(19) United States
(12) Patent Application Publication
(10) Pub. No.: US 2003/0122863 A1
(43) Pub. Date: Jul. 3, 2003

(54) Navigation tool for slide presentations

(75) Inventors: Andreas Dieberger, San Jose, CA (US); Cameron Shea Miner, San Jose, CA (US); Dulce Beatriz Ponceleon, Palo Alto, CA (US)

Correspondence Address: Marc D. McSwain, IBM Corporation, Almaden Research Center, 650 Harry Road, San Jose, CA, 95120, US

(73) Assignee: International Business Machines Corporation

(21) Appl. No.: 10/034,149

(22) Filed: Dec. 28, 2001

(51) Int. Cl. G09G 5/00

(52) U.S. Cl. 345/730

(57) ABSTRACT

A system and method for navigating a computer-based slide show during presentation to an audience. A preferably transparent summary view presents time data for each slide, and depicts each slide as a cell. The contents of each cell visually convey information about the slide. Brushing a cell triggers the display of a thumbnail view of a corresponding slide. Selection of a cell causes a corresponding slide to be displayed; if that slide is not next in a predetermined presentation sequence, then a jump marker is affixed to the cell corresponding to the sequence departure point so the presenter can resume the sequence directly after completing a detour. The summary view can also generate a visual, audible, and vibrational warning of the relative time remaining for a given slide from an initial allotment. The invention can also recompute the allotment for slides not yet displayed, and save time data to a file.

### FIELD OF THE INVENTION

This invention relates to a tool for helping a presenter of a digital slide show flexibly navigate within the presentation without loss of narrative flow, and to better manage presentation time.

### DESCRIPTION OF RELATED APPLICATIONS

This application is related to two other commonly owned and concurrently filed applications, “System and Method for Visualizing and Navigating Content in a Graphical User Interface” (attorney docket number ARC920010059US1) and “System and Method for Visualizing and Navigating Dynamic Content in a Graphical User Interface” (attorney docket number ARC920010063US1), which are incorporated herein by reference. A third commonly owned application, “System and Method for Non-Visually Presenting Multi-Part Information Pages Using a Combination of Sonifications and Tactile Feedback” (attorney docket number ARC920010019US1, filed on Apr. 24, 2001) is also incorporated herein by reference.

### DESCRIPTION OF RELATED ART

Slide presentation tools are computer programs that enable a user to create, edit, manage, and perform “presentations” on a computer. A slide presentation includes a set of electronic “slides”, each slide corresponding to one screen or page of output. Each slide contains one or more objects, such as text or graphical images. The slides comprising a presentation produced on a personal computer are stored together in a file. A slide presentation program “performs” a “slide show” by displaying a series of slides contained within the slide presentation. The slides may be displayed sequentially, but during the presentation it is also possible that the presenter would want to access images in a modified order. The slides are displayed on a display screen, which may be part of a computer monitor or a separate surface onto which an image is projected. During a performance of a slide show, a presenter controls the performance by invoking commands to advance the slide show. A command can be entered using a keyboard, a mouse, or other suitable input device.

A slide presentation tool executes on a computer, preferably a personal computer. The computer system generally comprises a central processing unit (CPU), an internal memory, and a permanent storage medium, such as a disk drive. The computer system also includes a keyboard and a pointing device, such as a mouse, for entering commands and data. The CPU and a display device such as a monitor generate a graphical user interface that is shown on a display screen. Preferably, the computer system further includes circuitry, such as a sound card, for playing audio signals through an audio output device, such as a speaker. An operating system and a slide presentation application program, as well as other programs, preferably reside in the internal memory and execute on the CPU.

U.S. Pat. No. 5,500,936 to Allen et al. teaches a relatively conventional popup menu that appears in response to a presenter's selection (e.g. actuating and releasing a mouse button), to help the presenter control a presentation. The menu is removed from the display after the presenter has chosen a command or pressed the ‘escape’ key.

U.S. Pat. No. 6,008,807 to Bretschneider et al. teaches a system for viewing a slide show presentation featuring three operational modes, each mode having desirable user interface elements. The presentation mode enables a presenter to move forwards and backwards through a list of slides presented in a context menu, and to control the activation of slide ‘builds’, which are objects that can sequentially appear on a given slide. The Bretschneider system also enables a presenter to jump to slides outside the predetermined sequence of slides.

U.S. Pat. No. 5,917,480 to Tafoya et al. teaches a presentation system having a control window that may be invoked during a slide show. The control window has the appearance of a file folder and is designed primarily for adding material to a presentation in the form of notes, meeting minutes, and action items. The overall goal of the invention is to increase interaction with content during presentation.

U.S. Pat. No. 6,037,943 to Crone et al. teaches a navigation tool for slide presentations including an on-screen indicator with several fields enabling a presenter to “push into” a hierarchy of slides to change the order of slide presentation. The indicator is a “navigational monolith” that includes a descriptor field for displaying text, numbers, or symbols to help the presenter find a particular slide.

While the aforementioned prior art tools are useful advances in the field of electronic slide presentation software, tools that provide further ease of use could be developed. An application that is focused primarily on improved slide show presentation versus authoring, editing, rehearsal, or appending information to a slide show would be simpler to use and less likely to cause presenter confusion and loss of narrative flow. Retaining audience attention and reducing distractions during the delivery of a live presentation is paramount. Most slide shows are not overly complex and include only 30 to 40 slides, so a complicated all-purpose presentation application probably includes more features than a typical presenter needs.

Presenters need a tool to help answer these questions during a presentation:

Where am I in the presentation?

How many more slides do I have?

How many more slides until I get to a particular slide?

Where is slide X (without having to actually go to that slide)?

How can I jump to a particular slide to answer an audience question and then easily jump back to where I left off?

How can I tell which slides have been shown and which ones have been skipped?

How much more time do I have?

How long can I talk about each remaining slide?

These questions should be answered without hiding a current slide from the audience in order to avoid interrupting the narrative flow of the presentation. Similarly, the process of looking through the slides to find a slide needed to answer an audience question needs to avoid presenting slides out of order or prematurely, as this might give away results or the “punch line” out of the intended narrative sequence. A streamlined presentation tool would help keep a slide show immersive and engaging, avoiding awkard pauses, interruptions, and side-trips with difficult returns to the main narrative. A tool having a few simple and easily accessible features is also likely to reduce presenter stress. Stress is a major factor in presenters becoming distracted and running over allotted time limits and thus failing to deliver their presentations in the most effective manner. An audience that perceives a presenter as being nervous and disorganized is less likely to pay attention to the material being presented and may question the presenter's competence. An improved system for managing slide presentation time and enabling simpler navigation of presentations is therefore needed.

### SUMMARY OF THE INVENTION

It is accordingly an object of this invention to devise a tool for managing the presentation of a computer-based slide show. The slides in the slide show are portrayed in a summary view in a graphical user interface as a slide map or sequential arrangement of cells corresponding to the slides. Each cell visually depicts data describing the slide it represents. The slides are stored in a file, typically created by a slide creation tool. The slides are cached in computer memory or otherwise made ready for immediate generation and display in response to presenter commands. The current slide is always displayed in the graphical user interface, regardless of whether the summary view has been invoked by the presenter.

The slide map preferably forms a vertical strip displayed on the far left side of the graphical user interface, with the top cell representing the first slide in the slide show, and subsequent cells representing subsequent slides. The summary view is transparent to be as non-intrusive as possible, being displayed on command over a slide displayed in the graphical user interface.

The colors, highlighted outlines, and shading patterns of cells convey slide data to a presenter, including identification of the slide currently being displayed, which slides have already been displayed, and which slides were skipped. Slides may also be categorized for better management during presentation; some slides are critical to the presentation, while others may contain only supporting examples and can be skipped over if time is short without significantly impacting presentation flow. Some slides may be for the presenter's use only, and are not to be displayed to an audience. Other slides may contain items other than simple text and images.

It is a related object that time data relating to individual slides and to the slide show as a whole be made available to the presenter via the summary view, so that the presenter will be better able to pace the presentation. A timing window in the summary view displays for example the elapsed presentation time, the presentation time remaining, the duration for which each slide has been displayed, and the remaining time per slide that has not yet been displayed. The summary view can present the actual slide display time in a histogram corresponding to the sequential arrangement of cells, and can save such time data to a log file.

The summary view can generate a moving visual indicator to depict time data during a presentation more intuitively. A tick mark can move across the width of the graphical user interface during the time allotted for each slide or for the slide show as a whole. The relative distance the visual indicator moves in the display corresponds to the relative elapsed time. When a time limit is approaching, the summary view can generate a warning for the presenter. The warning may be a subtle color change in slide backgrounds, for example, or may be an audible indication.

It is a related object that navigation to various slides in the slide show be kept as simple as possible to prevent a presenter from displaying slides in an unintended order or otherwise interrupting the narrative flow. The up and down cursor keys for example may increment and decrement the slide displayed in the graphical user interface. A single stroke of a particular key (e.g. the SHIFT key) invokes the summary view, and another such keystroke dismisses the summary view. The summary view portrays a thumbnail version of a slide being “brushed”, that is, highlighted in the slide map in response to user commands but not displayed at full size unless actually selected. Brushing can be accomplished via the cursor keys, a mouse, or any other pointing device. Selection of a given slide can optionally cause the summary view to be dismissed. The thumbnail version of a slide enables a presenter to identify a particular slide without resorting to the use of a slide sorter. The text in a thumbnail version of a slide is too small to be read by an audience, but can be recognized by the presenter; this ensures that the key points or “punch lines” of a slide are not prematurely revealed.

It is a related object that if the presenter decides not to strictly follow the predetermined slide display sequence, then means for returning to the predetermined slide display sequence in a smooth manner are provided. When a presenter begins a detour, the summary view places a jump marker near the cell representing the departure point. The presenter can preview any slide via thumbnail portrayal, and can cause any selected slide to be displayed in the graphical user interface. The presenter can then return instantly to the departure point via a single keystroke, causing the departure point slide to be immediately displayed. Another such keystroke can cause the display to toggle between the departure slide denoted by the jump marker and the last slide displayed in the presenter's detour.

It is a related object that when the summary view is not invoked, the presenter can trigger (using for example the P key in a momentary manner) the depiction of thumbnail versions of at least one previous and subsequent slide within the current slide. These thumbnails are preferably located in the lower corners of the current slide and can help the presenter recover from a distraction.

The foregoing objects are believed to be satisfied by the embodiment of the present invention as described below.

### BRIEF DESCRIPTION OF THE DRAWINGS

FIG. 1 is a diagram of the graphical user interface including a currently displayed slide and summary view according to the preferred embodiment of the present invention.

FIG. 2 is a diagram of the summary view including a timing window and a slide map having cells depicting slide data for corresponding slides according to the preferred embodiment of the present invention.

FIG. 3 is a diagram of the summary view including a graphical preview of a skipped slide and a jump marker according to the preferred embodiment of the present invention.

FIG. 4 is a diagram of the graphical user interface including a displayed slide, summary view, and moving visual indicator according to the preferred embodiment of the present invention.

FIG. 5 is a diagram of a histogram in the summary view according to the preferred embodiment of the present invention.

FIG. 6 is a diagram of the graphical user interface including a displayed slide and thumbnails of previous and subsequent slides according to the preferred embodiment of the present invention.

### DETAILED DESCRIPTION OF THE PREFERRED EMBODIMENT

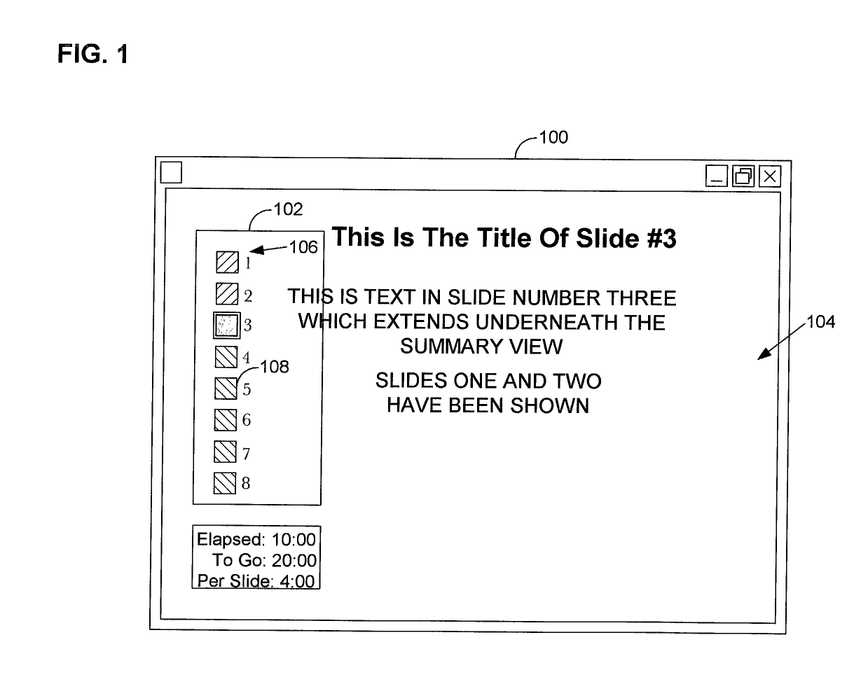

Referring now to FIG. 1, a diagram of the graphical user interface including a currently displayed slide and summary view according to the preferred embodiment of the present invention is shown. Graphical user interface 100 is preferably a window generated by a well-known operating system such as Windows 95 (R) available from Microsoft Corporation of Redmond, Wash., running for example on a personal computer such as a ThinkPad (R) available from IBM Corporation of Armonk, N.Y. Summary view 102 comprises a substantially transparent region that overlays current slide 104 but does not significantly impede viewing of current slide 104. Summary view 102 portrays at least some of the slides in the slide show as a slide map 106 which is a sequential arrangement of cells 108 corresponding to the slides. Each cell 108 visually depicts data describing the slide it represents, as will be detailed below. The slides are read from a file, typically created by a separate slide creation tool, such tools being well-known in the art. At least some of the slides are cached in computer memory (not shown) or otherwise prepared for immediate display when needed. Current slide 104 is always displayed in graphical user interface 100; that is, the audience has a slide constantly available for viewing and is not distracted by reversion to a slide sorter, for example. Invocation of summary view 102 by the presenter is not intended to significantly detract from the attention paid to current slide 104 by an audience. The presenter preferably triggers the appearance of summary view 102 with a single keystroke, and another such keystroke causes summary view 102 to disappear; repeated strokes of a single key thus generally toggle the activation and deactivation of features of the present invention.

The sequential arrangement of cells 108 preferably forms a vertical strip displayed on the far left side of graphical user interface 100, with the top cell representing the first slide in the slide show, and subsequent cells 108 representing subsequent slides. Alternately, the sequential arrangement of cells 108 can form a horizontal strip displayed on the bottom of graphical user interface 100, with slides generally proceeding from left to right. A hierarchy (not shown) of slide maps 106 can allow an increased number of slides to be depicted in summary view 102 if necessary, though most slide shows can be represented by a single slide map 106.

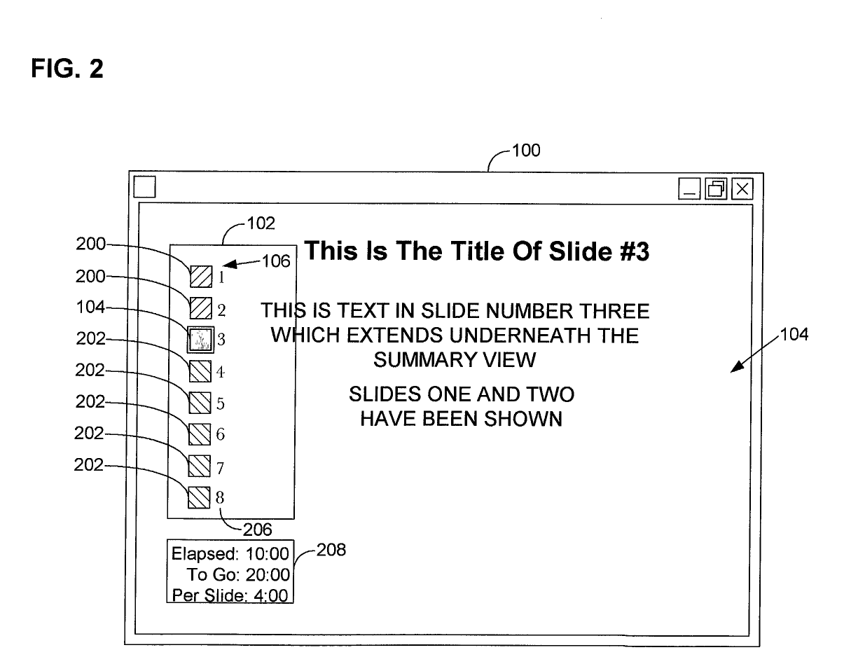

Referring now to FIG. 2, a diagram of summary view 102 including a timing window and slide map 106 according to the preferred embodiment of the present invention is shown. Slide map 106 includes visually distinctive cells 108 corresponding to shown slides 200, unshown slides 202, and current slide 104. Shown slides 200 are those that have been displayed continuously for a duration exceeding a specified threshold, e.g. three seconds. The threshold prevents a slide from being marked as shown when it was actually displayed only very briefly, and perhaps unintentionally. Skipped slides are simply unshown slides 202 within a range of shown slides 200, and are clearly distinguishable in slide map 106. Cells 108 convey slide data to a presenter via color, highlighted outlines, and shading patterns. Slide numbers 206 are also displayed in summary view 102.

Slides may also be categorized for better management during presentation, with different categories being differently visually represented by cells 108. Some slides are critical to the presentation and should be identified to the presenter as such, so they are not inadvertently skipped. Other slides may contain only supporting examples or references and can be skipped over if time is short without significantly impacting presentation flow. Of course, if the presenter has more time than was initially anticipated, example slides may be used to lengthen the overall presentation. Some slides may contain speaker notes for example, and are intended for the presenter's use only and not should not be displayed to the audience. The invention automatically skips over such hidden slides during presentation. Finally, some slides may contain demonstration materials other than simple text and images. Demo slides can include enhancements like multimedia documents, animations, hyperlinks, and audio files. Demo slides should correspond to visually distinctive cells 108 so a presenter can for example make equipment modifications or dim lights before initiating display of such enhancements.

A timing window 208 is also included in summary view 102. Timing window 208 portrays time data relating to individual slides and to the slide show as a whole, so that the presenter will be better able to control the pace of the presentation to fit into an allotted time. The elapsed presentation time and the remaining presentation time are displayed and continuously updated in timing window 208. Similarly, the duration for which current slide 104 (and other slides) has been displayed can also be shown in timing window 208. Further, the remaining time per as-yet-undisplayed slide can be computed from the remaining presentation time and the number of unshown slides 202, and displayed in timing window 208.

Navigation to various slides in the slide map 106 is kept as simple as possible to prevent a presenter from displaying slides in an unintended order or otherwise interrupting the narrative flow. A single keystroke, for example pressing the SHIFT key, invokes summary view 102, and another such keystroke removes summary view 102 from display. Up and down cursor keys increment and decrement the particular slide that is represented by an indicated cell 108 in slide map 106 if summary view 102 is invoked; if summary view 102 is not invoked then up and down cursor keys increment and decrement the particular slide that is displayed (i.e. current slide 104). Pressing HOME or END keys cause the first or final slide, respectively, in a slide show to be displayed; if summary view 102 is invoked then the HOME and END keys cause the particular cell 108 representing first or final slides, respectively, in slide map 106 to be highlighted. Selection of a highlighted cell 108 causes the slide corresponding to that cell 108 to be displayed. Selection of a given slide, for example by pressing the SPACE key, causes that slide to be displayed and can also optionally cause summary view 102 to disappear from graphical user interface 100.

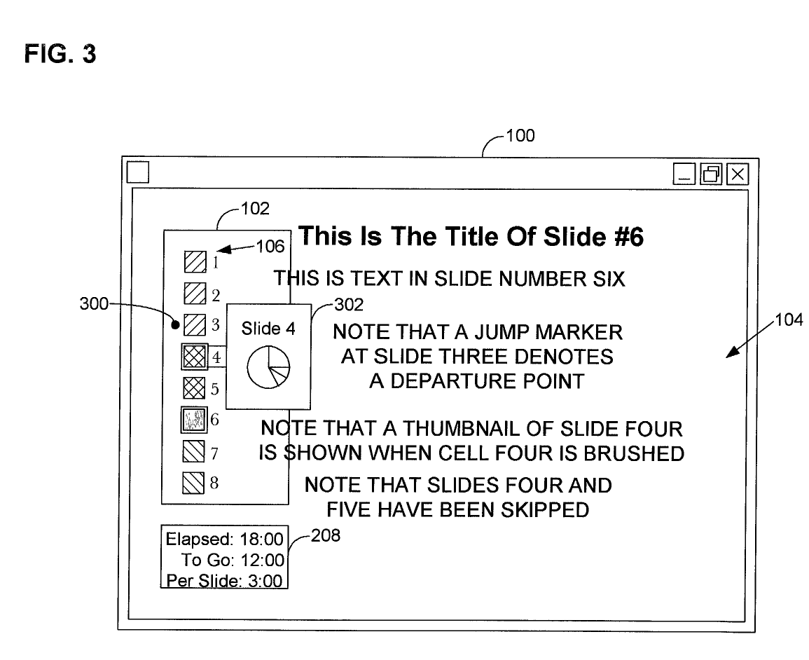

Referring now to FIG. 3, a diagram of the summary view including a graphical preview of a skipped slide and a jump marker according to the preferred embodiment of the present invention is shown. Jump marker 300 is for example a dot, an arrow, or other icon that summary view 102 places next to a departure point slide when a presenter chooses to jump to a slide that is not immediately before or after current slide 104 in slide map 106. In other words, if the presenter decides not to strictly follow the predetermined slide display sequence, then jump marker 300 enables the presenter to return to the predetermined slide display sequence in a smooth manner. Answering a question from the audience by showing a slide other than the next slide in the display sequence is a primary reason presenters embark on impromptu detours. When a presenter begins a detour by selecting a slide that is not an immediate ‘neighbor’ to current slide 104, summary view 102 places jump marker 300 near cell 108 representing the most recently displayed slide in the display sequence. Summary view 102 then displays the selected slide in graphical user interface 100. The presenter can return instantly to the departure point via a single keystroke (hitting the ESC key, for example); the departure point slide is immediately displayed and the audience is not made to endure a reverse traversal of intervening slides. Another such keystroke can toggle current slide 104 between the departure slide denoted by the jump marker and the last slide displayed during the presenter's detour, in case the presenter needs to return to answer a follow-on question from the audience, for example.

The presenter may not remember which slide contains particular content, however, so direct navigation to a particular slide might not be so easy. Summary view 102 therefore displays a miniature or thumbnail version 302 of a slide being “brushed”, that is, highlighted in slide map 106 in response to presenter commands but not displayed at full size in graphical user interface 100 unless actually selected by the presenter. Brushing can be accomplished via the cursor keys, a mouse, or any other pointing device that allows the presenter to roam over slide map 106 and thus highlight cells 108 corresponding to slides to be depicted in thumbnails 302. Thumbnail 302 enables a presenter to identify a particular slide without resorting to a slide sorter. The text in thumbnail 302 is too small to be read by an audience, but can be read by the presenter; this ensures that the key points or “punch lines” of a slide are not prematurely revealed. A graphical preview via thumbnails 302 is thus superior to a mere text preview the audience could read, and if a particular slide contains no text then a textual previewer would show a slide as a blank screen, disrupting narrative flow. The presenter can preview any slide using the brushed cell graphical preview mode, and can cause any highlighted slide to become current slide 104 displayed in graphical user interface 100. Selecting a brushed slide can also optionally cancel the display of summary view 102.

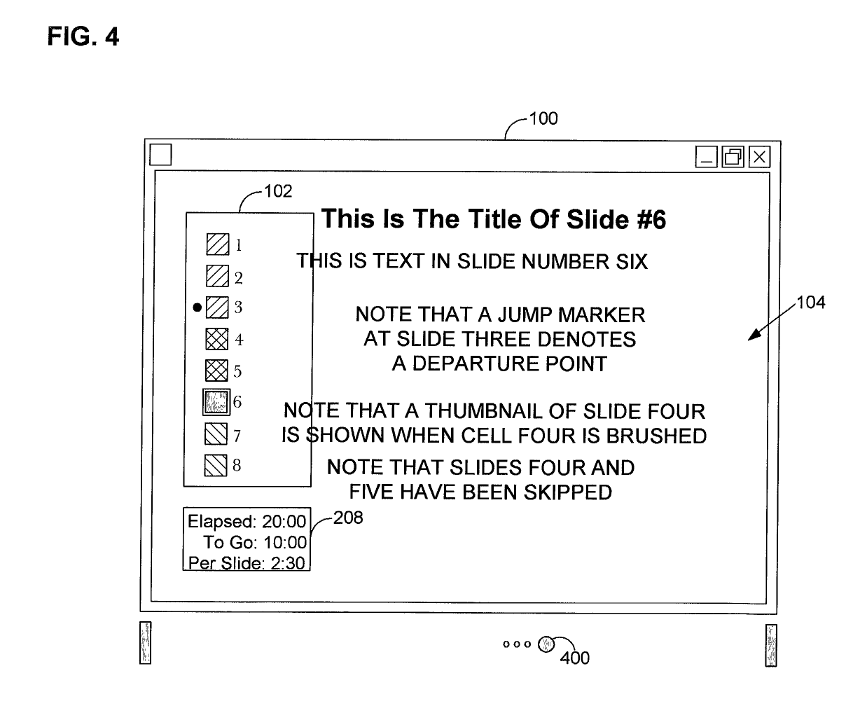

Referring now to FIG. 4, a diagram of the graphical user interface including a displayed slide, summary view, and moving visual indicator according to the preferred embodiment of the present invention is shown. Moving visual indicator 400 depicts time data during a presentation more intuitively than the chronological readouts described above in timing window 208. Moving visual indicator 400 can comprise a tick mark that moves across the width of graphical user interface 100 during the time allotted for each slide or, alternately, for the slide show as a whole. The relative distance that moving visual indicator 400 moves in the display corresponds to the relative elapsed time. When a time limit is approaching, e.g. 90% of allotted slide time or slide show time has elapsed, the present invention can generate a warning for the presenter (summary view 102 need not be visible for moving visual indicator 400 to be active). The warning can include a color change on moving visual indicator, from green to yellow and red for example. Alternately, moving visual indicator 400 may blink or flash or become progressively brighter to serve as a warning, though audience distraction might result. The present invention may also trigger an audible signal, but this may be distracting to the audience as well. A non-distracting tactile signal to the presenter can be employed as a warning instead. The tactile signal can be generated by a vibrating device such as a bracelet, necklace, or pager worn by the presenter.

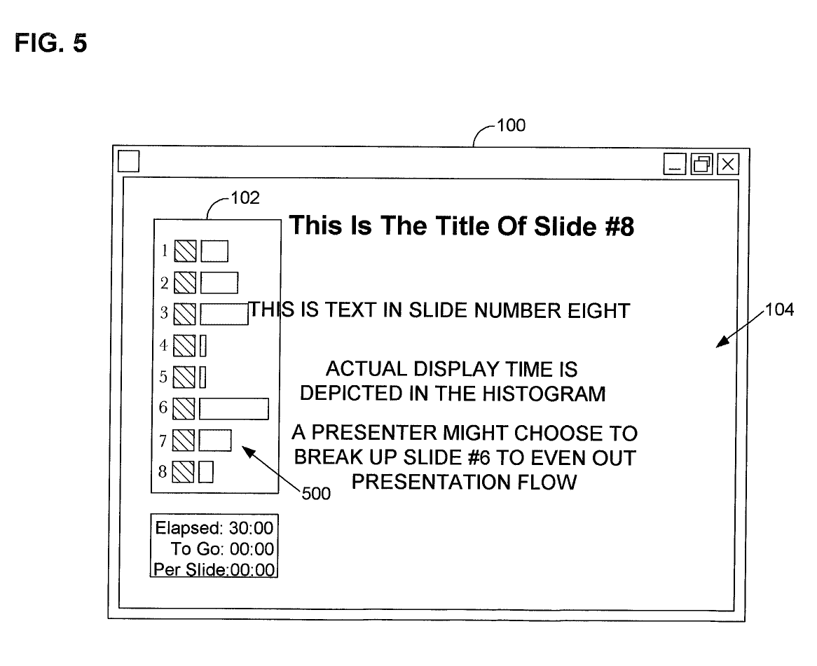

Referring now to FIG. 5, a diagram of a histogram in the summary view according to the preferred embodiment of the present invention is shown. Histogram 500 can be triggered by a keystroke on the letter H for example, and toggled off again by a subsequent keystroke as described before. Histogram 500 generated by summary view 102 presents the actual slide display time, versus rehearsal timing, corresponding to slide map 106. The present invention can save display time data to a log file for subsequent analysis. For example, if a given slide was displayed for a much longer time than average, then the presenter may decide to split that slide into several slides for future presentations. Similarly, if the actual presentation order differed substantially from the predetermined presentation sequence due to numerous lengthy detours, a reorganization of the presentation may be needed so that future audiences will find the presentation more effective.

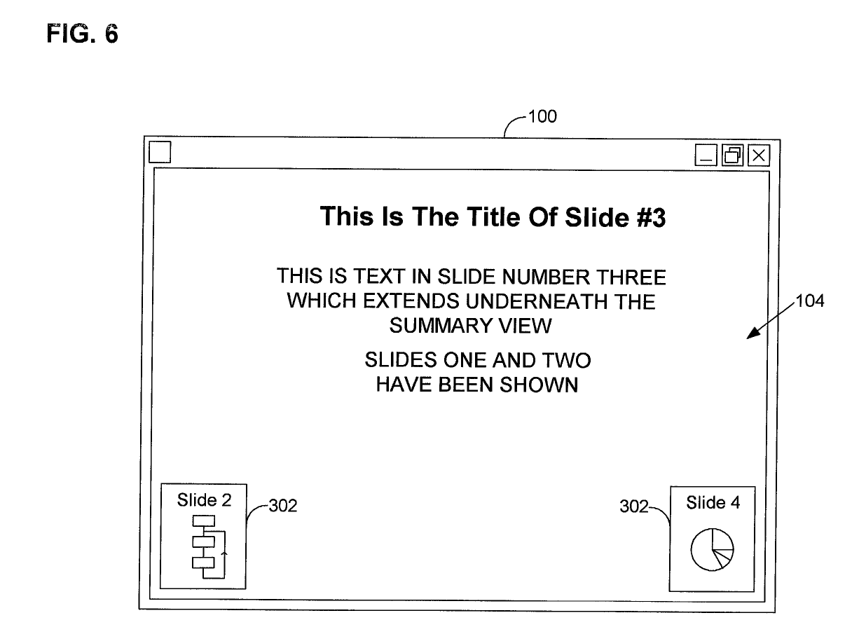

Referring now to FIG. 6, a diagram of graphical user interface 100 including current slide 104 and thumbnail versions 302 of previous and subsequent slides according to the preferred embodiment of the present invention is shown. The presenter can enable the momentary depiction of thumbnails 302 by holding down a key (for example, the P key for “preview”) when summary view 102 has not been invoked. Releasing the key dismisses thumbnails 302. Although only one previous and one subsequent slide are shown as thumbnails 302 in this exemplary embodiment, depiction of a different number of thumbnails 302 including previous slides or subsequent slides is within the scope of this invention. Additionally, differently sized thumbnails 302 may denote slides that are different distances from current slide 104 in the presentation.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular NAVIGATION TOOL FOR SLIDE PRESENTATIONS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

We claim:

1. A method for managing presentation of a computer-based slide show, comprising the steps of:
portraying at least some of a plurality of slides as a sequential arrangement of corresponding cells visually depicting slide data in a summary view in a graphical user interface;
furnishing time data describing said presentation of said slide show in said summary view; and
selecting at least one of said slides for display in said graphical user interface.

2. The method of claim 1 wherein said slides are stored in a file.

3. The method of claim 1 wherein said sequential arrangement of corresponding cells is substantially vertically oriented on a left portion of said graphical user interface.

4. The method of claim 1 wherein said sequential arrangement of corresponding cells is substantially horizontally oriented on a bottom portion of said graphical user interface.

5. The method of claim 1 wherein said cells visually depict said slide data using at least one of colors, highlighted outlines, shading patterns.

6. The method of claim 1 wherein said slide data includes at least one of: which of said slides is currently displayed in said graphical user interface, a slide number, which of said slides has been displayed for more than a predetermined duration, which of said slides is a critical slide, which of said slides is an example slide, which of said slides is a hidden slide.

7. The method of claim 1 wherein said slide data includes which of said slides has an enhancement portion including at least one of: a multimedia document, an animation, a hyperlink, an audio file.

8. The method of claim 1 wherein said time data includes at least one of: an allotted presentation time for said slide show, an elapsed time for said slide show, a remaining time for said slide show, a total display time for each of said slides, a remaining display time for each of said slides according to a predetermined schedule.

9. The method of claim 1 comprising the further step of updating an allotted display time for each of said slides being as yet undisplayed, based on a remaining time for said slide show and a count of said undisplayed slides.

10. The method of claim 1 comprising the further step of saving said time data to a log file.

11. The method of claim 1 comprising the further step of displaying said time data as a histogram in said summary view.

12. The method of claim 1 wherein said time data is displayed in a timing window in said summary view.

13. The method of claim 1 wherein said summary view is substantially transparent.

14. The method of claim 1 wherein said summary view depicts said time data by moving a visual indicator across a distance representing an elapsed time relative to an allotted time.

15. The method of claim 14 wherein said elapsed time and said allotted time refer to one of said slides.

16. The method of claim 14 wherein said elapsed time and said allotted time refer to said slide show.

17. The method of claim 1 comprising the further step of warning a presenter when a time limit is approaching by performing at least one of these additional steps: changing a color of a visual indicator, flashing said visual indicator, triggering an audible signal, triggering a tactile signal.

18. The method of claim 17 wherein said tactile signal is generated by at least one of: a vibrational bracelet, a vibrational necklace, a vibrational pager.

19. The method of claim 1 wherein a hierarchy of said sequential arrangements enables depiction of an increased number of said slides.

20. The method of claim 1 wherein a presenter keystroke triggers generation of said summary view and another presenter keystroke triggers removal of said summary view.

21. The method of claim 1 wherein said summary view portrays a thumbnail version of a brushed slide corresponding to a brushed cell.

22. The method of claim 21 wherein a selection of said brushed cell corresponding to said brushed slide causes said brushed slide to be displayed in said graphical user interface.

23. The method of claim 22 wherein said selection of said brushed cell corresponding to said brushed slide causes removal of said summary view.

24. The method of claim 22 wherein if said brushed slide is not a next slide in said sequential arrangement then said summary view places a jump marker at a departure slide.

25. The method of claim 24 wherein a presenter keystroke returns navigation to said departure slide causing said departure slide to be displayed and another presenter keystroke returns navigation to said brushed slide causing said brushed slide to be displayed.

26. The method of claim 1 wherein said slides are cached for faster display.

27. The method of claim 1 wherein at least one thumbnail version of at least one previous slide and at least one subsequent slide are displayed in said graphical user interface in response to a presenter keystroke.

28. A system for managing presentation of a computer-based slide show, comprising:
a computer including a cpu, an internal memory, a data storage device, an input device; and
a display device, for portraying at least some of a plurality of slides as a sequential arrangement of corresponding cells visually depicting slide data in a summary view in a graphical user interface,
wherein said summary view furnishes time data describing said presentation and wherein at least one of said slides is selected for display in said graphical user interface using said input device.

29. A system for managing presentation of a computer-based slide show, comprising:
means for portraying at least some of a plurality of slides as a sequential arrangement of corresponding cells visually depicting slide data in a summary view in a graphical user interface;
means for furnishing time data describing said presentation of said slide show in said summary view; and
means for selecting at least one of said slides for display in said graphical user interface.

30. A computer program product comprising a machine-readable medium having computer-executable program instructions thereon including:
a first code means for portraying at least some of a plurality of slides as a sequential arrangement of corresponding cells visually depicting slide data in a summary view in a graphical user interface;
a second code means for furnishing time data describing said presentation of said slide show in said summary view; and
a third code means for selecting at least one of said slides for display in said graphical user interface.
